(19) United States
(12) Patent Application Publication
(10) Pub. No.: US 2009/0053520 A1
(43) Pub. Date: Feb. 26, 2009

(54) Adhesive Composition and Process

(76) Inventors: Victor Lu, Smyrna, GA (US); Jeffrey Wang, Smyrna, GA (US)

Correspondence Address: WENDEROTH, LIND & PONACK, L.L.P., 2033 K STREET N. W., SUITE 800, WASHINGTON, DC, 20006-1021, US

(21) Appl. No.: 11/887,827

(22) PCT Filed: Apr. 28, 2006
(86) PCT No.: PCT/EP2006/004007

§ 371 Date: Oct. 4, 2007

Related U.S. Application Data
(60) Provisional application No. 60/676,295, filed on May 2, 2005.

(51) Int. Cl. C08G 18/72; B32B 7/12

(52) U.S. Cl. 428/355 N; 522/174; 528/59

(57) ABSTRACT

There is disclosed a curable PSA made by a solventless single stage polymerisation of the following materials: from about 10% to about 80% by weight of at least one polyol which has molecular weight at least 1000 daltons; from about 0.5% to about 20% at least one poly-isocyanate(s) from about 0.1% to about 10%, by weight of at least one hydroxyl(meth)acrylate(s); from about 10% to about 80% by weight of one or more tackifier resins.

This present invention relates to a process for the production of a radiation crosslinkable adhesive and more specifically, it relates to an optionally hot melt process for the production of an adhesive such as an acrylated urethane polymer-based adhesive. The invention also relates to a process for making formulations that can be useful as radiation curable pressure sensitive adhesives (PSAs) and/or as laminating adhesives.

### BACKGROUND OF THE INVENTION

Radiation crosslinkable adhesives such as pressure sensitive adhesives or laminating adhesive can produced by either solvent process or solventless process.

Solvent process is widely known methods for production of radiation crosslinkable adhesives. It normally involves the following three steps: (1) A radiation crosslinkable resin (polymer, copolymer, or their blend) solution is made by polymerization of monomers(such as acrylic polymer solution) or by chemical modification of oligomer (such as acrylated urethane polymer from polyol oligomer) in solvent; (2). Other functional additives such as tackifying resin and photo-initiator are dissolved in the resin solution; (3) Solvent is evaporated to result in the end-product. However, solvent processes suffer from a number of major shortcomings, including longer production time, higher energy consumption, and more difficulties in the control of the production process and final product quality. More importantly, such processes can not remove solvent completely under normal production conditions and the end-product always contains some residual solvents which can results in not only the emission of solvent vapors during application but also poorer performance. In other words, the end-product made by solvent process is not really free of VOC.

Solventless process is more desirable for production of radiation crosslinkable adhesive because it involves 100% convertible materials with a simpler and more economical manufacture practice. There are several prior arts that describe different solventless processes for making radiation crosslinkable adhesive, but most of those prior arts are related to the radiation polymerization of acrylic monomers to make radiation crosslinkable acrylic adhesives.

U.S. Pat. Nos. (4,181,752, 4,364,972, and 4,243,500) disclose a actinic radiation processing for preparation of an acrylic PSA by photopolymerizing an alkyl acrylate and a polar copolymerizable monomer (e.g., acrylic acid, N-vinyl pyrrolidone, etc.). However, the performance of this type of adhesive is very sensitive to processing conditions as well as the thickness of the composition.

U.S. Pat. No. 5,741,5431 describes a syrup polymer process in which a partially prepolymerized composition is coated onto a substrate and crosslinked to form a PSA by polymerizing free radical polymerizable monomers from convalently attached pendent unsaturation in polymer component of the composition. This process is also sensitive to the process condition as well as the thickness of the composition.

U.S. Pat. No. 6,436,532 discloses a multi-stage irradiation process for the production of an acrylic-based adhesive. In this process, a mixture of acrylic monomer or partially prepolymerized syrup is irradiated with electromaggnetic radiation first at a relatively low average intensity and subsequently at a higher average intensity.

U.S. Pat. No. 5,879,759 describes a two-step method for the production of a PSA by radiation curing. The method comprises the steps of irradiating a soft monomer composition to form a coatable syrup, followed by adding at least one hard monomer and one multifunctional monomer or oligomer to the syrup, and further irradiating the mixture to form a PSA.

However the solventless processes above have a number of common disadvantages. Because of low molecular weight (Mw) of monomers, it is virtually impossible to polymerize them into high Mw end-product in the curing time frames usually encountered in the real production. Also, those processes are not practical for bulk batch production because the starting materials to form a very thin layer so that irradiation can penetrate the material to get homogeneous polymerization.

There is still a need to overcome the disadvantages and limitation that exist with both solvent processes and solventless processes for production of radiation crosslinkable adhesives.

A preferred objective of the present invention is to provide method(s) of making acrylated urethane polymer-based adhesive composition which is 100% solid and free of volatile organic compounds (VOCs).

Another preferred objective of the invention is to provide adhesive compositions that are radiation curable (for example with actinic and/or ionizing radiation such as ultraviolet light or electron beams), more preferably with a high UV-cure speed.

A further preferred objective of the invention is to provide adhesive compositions which under warm melt conditions exist in a liquid state of sufficiently low viscosity (preferably less than or equally to about 25,000 centipoise) to be able to applied as a coating to suitable substrates. Suitable warm-melt conditions are at a temperature from about 40° C. to about 130° C.

A still yet other preferred objective of the invention is to provide adhesive compositions with high post cure adhesion to various substrates, particularly to substrates with low surface energy, comparable to solvent-bone adhesives.

### SUMMARY OF THE INVENTION

In accordance with the present Invention, the applicant has now discovered a new preferably solvent-less process for the production of acrylated urethane polymer-based radiation crosslinkable adhesive.

Broadly the invention comprising the reaction product obtainable by polymerising the following materials, preferably in the absence of solvent:
(a) about 10% to about 80%, preferably from about 25% to about 50%, more preferably from 30% to about 40%, for example about 35% by weight of at least one polyol which has molecular weight at least 1000 daltons preferably from about 1,000 to 10,000 daltons, more preferably from about 2,000 to about 5,000 daltons, for example 3,000 daltons.
(b) from about 0.5% to about 20%, preferably from about 1.0% to about 10%, more preferably from about 1.0% to about 5%, for example about 3% by weight of at least one poly-isocyanate(s) for example from 2 to 4 different poly-isocyanate(s);
(c) from about 0.1% to about 10%, preferably from 0.1% to about 5% more preferably from 0.1% to about 1.0% most preferably from about 0.1% to about 0.5% for example about 0.2% by weight of at least one hydroxyl(meth)acrylate(s) for example from 2 to 6 different hydroxyl(meth)acrylate(s). Preferably the (meth)acrylates contains an average from about 1.5 to about 2.5, more preferably about 2.0 hydroxy groups per molecule.
(d) from about 10% to about 80%, preferably about 15% to about 60%, more preferably about 30% to about 60%, most preferably about 40% to about 60%, for example from about 50% to about 60% such as about 55% by weight of one or several of tackifier resins that are compatible to these materials (such as these oligomers/polymers), for example hydrocarbon tackifiers;
(e) optionally from about 0% to about 90%, preferably about 1% to about 30% more preferably about 2% to about 25%, most preferably about 3% to about 10%, for example about 5% by weight of one or several of multifunctional (meth)acrylate monomers that are compatible these materials (such as these oligomers/polymers)
(f) optionally from about 0.1% from about 10.0%, preferably from about 0.5% to about 5% by weight of photo-initiator(s), preferably from about 0.5% to about 1.5%, for example about 1.0% by weight of photo-initiator(s). Optionally, no photoinitiator is used if the formulation is to be cured by electron beam; and
(g) optionally from about 0% to about 10% by weight of other additives such as antioxidant (s), UV-stabilizer(s), wetting agent(s), flowing agent(s) and any other additive that would be well known to those skilled the art.

Another aspect of the invention is a process comprising the step of polymerising the previous materials (a) to (g) in a single vessel in the absence of solvent.

The process and composition of the present invention results in a radiation crosslinkable adhesive having coatable viscosity (5000 to 30000 cps) at warm melt temperature range (about 40 to about 130° C.). After radiation crosslinked, the adhesive has excellent peel adhesion and shear cohesion at both ambient and elevated temperatures.

In the present invention, the tackifying resin plays two important functions. Firstly, it functions as the diluent during the reaction so that the reaction can take place at much higher temperature and complete in much short time than conventional solvent processes. Secondly, after UV cured, it can tackify the formulation to improve the adhesion properties of the end-product. Also, this process avoids the manufacture step for solvent removal and offers more flexibility to different end-products simply by change of the ratio of level or type of the tackifier.

### DETAILED DESCRIPTION OF THE PRESENT INVENTION

The process of the present invention involves the chemical reaction in a hot melt mixture of polyols, polyisoisocyanates, hydroxyl(meth)acrylates, tackifying resin, and optionally multifunctional monomers to form a radiation crosslinkable adhesive. The adhesive can be applied to substrates at warm melt temperature range and then are irradiated to from a pressure sensitive adhesive or a laminating adhesive product.

Polyols, polyisocyanates, Hydroxy(meth)acrylates, and other suitable components for use in the invention are now described.

### Polyols

The useful polyols in the present invention are oligomers having at least two terminal hydroxyl group such as polyester polyols, acrylic polyols, polyether polyols, rubber-derived polyols, and mixtures thereof. The molecular weight range of those polyols is from about 500 to 100,000, preferably 1000 to 10000 daltons. Some examples of commercial polyols suitable for the present invention include, but are not limited to, hydroxyl terminated poly(oxyalkylenes)(Poly-G 20-56, POLY-G 30-56, POLY-G-55-56, POLY-G 30-28 from Arch Chemicals), poly(tetrahydrofuran) diols ( POLY-THF MW650, POLY-THF 2000 and POLY-THF 4500 from BASF), acrylic polyols(Acryflow P-120 from Lyondell Chemical), polytetramethyleneetherglycol (Terathane III from Dupont), polyester polyols from hexanedioic acid and 2,2,4-trimethyl-1,3-pentanediol (LEXOREZ 1180-35 from Inolex Chemical), poly(ethylene/butylene) polyols(KRATON LIQUID L-2203, from Karton Polymers), and polybutadiene polyol(POLY bd R-45HTLO, from Sartomer).

The choice of polyols depends on the requirement of an end-use and the compatibility with other components such as tackifiers, monomers, and polyioscyanates. For example, rubber-derived polyols is preferred for a PSA having high adhesion on low surface energy substrates.

### Polyioscyanates

Suitable polyisocyanates of the present invention may be obtained and/or obtainable from one or more poly-isocyanates, preferably di-isocyanates, more preferably aliphatic, cycloaliphatic, heterocyclic and/or aromatic di-isocyanates. Convenient diisocyanate(s) are those which may be used to obtain polymer(s) having linear structures.

In the method of the present invention aliphatic di-isocyanates are preferred as aromatic groups absorb UV radiation during curing which reduces the speed in which the finished cured adhesive can be obtained. More preferably cycloaliphatic diisocyanates are used as these can produce polymers with a high storage modulus. If an electron beam is used to cure the adhesive then cure speed is not significantly effected and the cheaper aromatic diisocyanates are preferred over aliphatic diisocyanates.

Preferred di-isocyanates that may be used in the present invention are selected from: alkyl (more preferably methyl) dialkylene (more preferably di-C₁₋₄alkylene) diisocyanate benzenes, alkyl (more preferably methyl) diphenylene diisocyanates, optionally alkyl substituted diphenylmethane diisocyanates, alkyldiene (more preferably C₁₋₁₀alkyldiene) diisocyanates, optionally alkoxy substituted naphthylene diisocyanates optionally where any aromatic and/or ethylenic groups therein have been partially and/or completely hydrogenated.

Dimethoxybenzidine diisocyanates, di(isocyanatoethyl)bicycloheptene-dicarboxylate, mono, or di halo (preferably bromo) toluene and phenylene diisocyanates, and/or mixtures thereof, and/or similar and/or analaogous di-isocyanates; including but not limited to isocyanate functional biurets thereof, allophonates thereof, and/or isocyanurates thereof; and/or mixtures thereof.

Examples of specific di-isocyanates that may be used in the present invention are selected from:

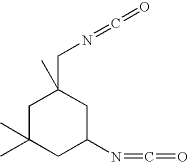

3-isocyanatomethyl-3,5,5-trimethylcyclohexylisocyanate (isophorone diisocyanate or IPDI),

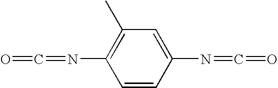

2,4-toluene diisocyanate,

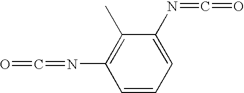

2,6-toluene diisocyanate and mixtures thereof TDI):

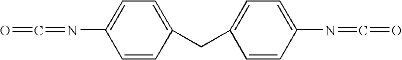

4,4′-diphenylmethane diisocyanate (MDI),

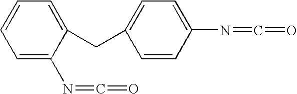

2,4′-diphenylmethane diisocyanate,

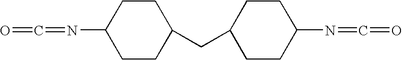

4,4′-dicyclohexyldiisocyanate or reduced MDI (also known as diclohexanemethane diisocyanate),

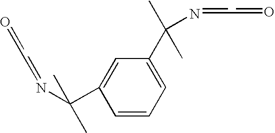

meta-tetramethyl xylene diisocyanate;

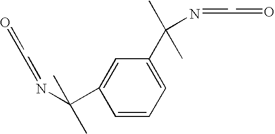

para-tetramethyl xylene diisocyanate (TXMDI) and mixtures thereof,

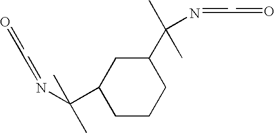

hydrogenated meta-tetramethyl xylene diisocyanate [1,3-bis(isocyanatemethyl)cyclohexane],

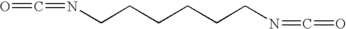

hexamethylene diisocyanate (HDI),

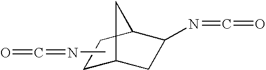

norbornane diisocyanate (NBDI),

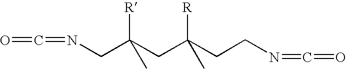

2,2,4- and 2,4,4-trimethylenehexamethylene diisocyanate (R=H, R′=CH₃; 2,4,4 isomer; R=CH₃, R′=H; 2,2,4 isomer) and/or mixtures thereof (TMDI);

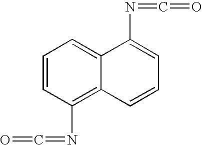

1,5-naphthylene diisocyanate (NDI),

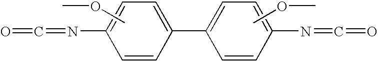

Dimethoxybenzidine diisocyanate (dianisidine diisocyanate) di(2-isocyanatoethyl)bicyclo[2.2.1]-hept-5-ene-2,3-dicarboxylate,

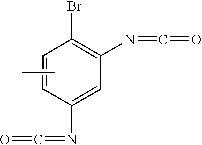

2,4-bromotoluene diisocyanates,

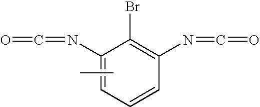

2,6-bromotoluene diisocyanates and/or mixtures thereof,

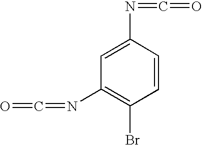

4-bromo-meta-phenylene diisocyanate,

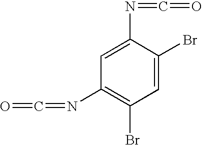

4,6-dibromo-meta-phenylene diisocyanate,
and/or similar and/or analaogous di-isocyanates; including but not limited to isocyanate functional biurets thereof, allophonates thereof, and/or isocyanurates thereof; and/or mixtures thereof.
Hydroxyl (meth)acrylates

Any suitable hydroxyl functional ethylenically unsaturated monomer(s) may be used herein. Preferred monomer(s) are mono hydroxy functional alkyl(meth)acrylate(s); more preferably hydroxyC₁₋₁₀ alkyl(meth)acrylate(s); optionally substituted with one or more alkoxy group(s); adducts thereof with caprolactone and/or mixtures thereof.

Examples of such hydroxyl (meth)acrylate(s) comprise: 2-hydroxyethyl acrylate (HEA) and methacrylate (HEMA); 2-hydroxypropyl (meth)acrylate, 3-hydroxypropyl (meth)acrylate, 2-hydroxybutyl (meth)acrylate; 4-hydroxybutyl (meth)acrylate, 3-hydroxypentyl (meth)acrylate, 6-hydroxynonyl (meth)acrylate; 2-hydroxy and 5-hydroxypentyl (meth)acrylate; 7-hydroxyheptyl (meth)acrylate and 5-hydroxydecyl (meth)acrylate; diethylene glycol mono(meth)acrylate, polyethylene glycol mono(meth)acrylate, propylene glycol mono(meth)acrylate, poly propylene glycol mono(meth)acrylate, and/or (meth)acrylates combining ethoxylated and propoxylated derivatives (available commercially from Cognis); caprolactone-2-hydroxyethyl acrylate adducts (such as available commercially from Dow/Union Carbide under the trademark Tone® M-100); and mixtures thereof.

### Tackifying Resins

The tackifying resins for the present invention may be selected from the group consisting of:

rosin tackifiers such as rosin acid, polymerized rosin acid, rosin esters and mixtures, and preferably hydrogenated rosin resin;
hydrocarbon resin such as aliphatic and/or cycloaliphatic hydrocarbon tackifier resins, and preferably hydrogenated hydrocarbon resin;
aromatic/aliphatic tackifier resins and preferably hydrogenated aromatic/aliphatic tackifier resins;
polyterpene and terpene phenolic resins;
aromatic resins polymerized from styrene, alpha-methyl styrene, vinyl toluene and mixtures;
phenolic modified aromatic resins, benzoate resins, coumarone-indene.

Some examples of commercial tackifiers suitable for the present invention include, but are not limited to, the aliphatic and/or cycloaliphatic hydrocarbon tackifier resins available commercially from ExxonMobil under the trade marks Escorez 5300 series with soft-point from 70-150° C.; the aromatic modified aliphatic tackifier resins available commercially from ExxonMobil under the trade marks Escorez 2000 series with soft-point from 10-100° C.; the hydrogenated and/or partially hydrogenated aromatic resins available commercially from Eastman Chemicals under the trade marks Regairez® 1018, 1085 1094, 3102, 1126, and/or PMR 1100; the polymerized aromatic resin available commercially from Eastman Chemicals under the trade marks Kristalex® 3070, 3085 and/or PM-3370; the rosin esters available commercially from Arizona Chemicals under the trade marks Sylvalite® RE 80HP (rosin ester); and Sylvares® TP7042 (high softening point (145-151° C.) thermally stable polyterpene phenol resin, TR 7115; TP2040 (thermoplastic terpene phenolic resin) and/or TR-1085 (polyterpene resin); the dicyclohexyl phthalate plasticizer and tackifier available commercially from Unitex Chemicals under the trade mark Uniplex® 280; the isobornyl acrylate and isobornyl methacrylate mono-functional cross-linker and tackifier monomers available commercially from Cytec Surface Specialties.

Optionally, one or more multifunctional reactive diluent can be used to lower viscosity as well as to adjust adhesion performance such as suitable (meth)acrylate monomers that compatible with the oligomers/polymers described herein.

Formulations of the invention may also comprise one or more of the following optional ingredients (amounts given as weight percentage of total formulation in the invention): one or more radiation curable polymer precursor(s), preferably in an amount from 0% up to 90%

one or more free radical photoinitiator(s); preferably in an amount from 1% up to about 10%;
one or more plasticizer(s); preferably in an amount from 0% up to about 15%;
one or more antioxidant(s); preferably in an amount from 1% up to about 10%;
one or more colorant(s), preferably in an amount from 0% up to about 40%; and/or any other ingredients that will be suitable.

Unless the context clearly indicates otherwise, as used herein plural forms of the terms herein are to be construed as including the singular form and vice versa.

The term “comprising” as used herein will be understood to mean that the list following is non exhaustive and may or may not include any other additional suitable items, for example one or more further feature(s), component(s), ingredient(s) and/or substituent(s) as appropriate.

The terms ‘effective’, ‘acceptable’ ‘active’ and/or ‘suitable’ (for example with reference to any process, use, method, application, preparation, product, material, formulation, compound, monomer, oligomer, polymer precursor, and/or polymer of the present invention and/or described herein as appropriate) will be understood to refer to those features of the invention which if used in the correct manner provide the required properties to that which they are added and/or incorporated to be of utility as described herein. Such utility may be direct for example where a material has the required properties for the aforementioned uses and/or indirect for example where a material has use as a synthetic intermediate and/or diagnostic tool in preparing other materials of direct utility. As used herein these terms also denote that a functional group is compatible with producing effective, acceptable, active and/or suitable end products. A preferred utility of the polymers of the present invention is as adhesives, more preferably pressure sensitive or laminating adhesives.

The terms ‘optional substituent’ and/or ‘optionally substituted’ as used herein (unless followed by a list of other substituents) signifies the one or more of following groups (or substitution by these groups): carboxy, sulpho, formyl, hydroxy, amino, imino, nitrilo, mercapto, cyano, nitro, methyl, methoxy and/or combinations thereof. These optional groups include all suitable chemically possible combinations in the same moiety of a plurality of the aforementioned groups (e.g. amino and sulphonyl if directly attached to each other represent a sulphamoyl group). Preferred optional substituents comprise: carboxy, sulpho, hydroxy, amino, mercapto, cyano, methyl, halo, trihalomethyl and/or methoxy.

The synonymous terms “organic substituent” and “organic group” as used herein (also abbreviated herein to “organo”) denote any univalent or multivalent moiety (optionally attached to one or more other moieties) which comprises one or more carbon atoms and optionally one or more other heteroatoms. Organic groups may comprise organoheteryl groups (also known as organoelement groups) which comprise univalent groups containing carbon, which are thus organic, but which have their free valence at an atom other than carbon (for example organothio groups). Organic groups may alternatively or additionally comprise organyl groups which comprise any organic substituent group, regardless of functional type, having one free valence at a carbon atom. Organic groups may also comprise heterocyclyl groups which comprise univalent groups formed by removing a hydrogen atom from any ring atom of a heterocyclic compound: (a cyclic compound having as ring members atoms of at least two different elements, in this case one being carbon). Preferably the non carbon atoms in an organic group may be selected from: hydrogen, halo, phosphorus, nitrogen, oxygen, silicon and/or sulphur, more preferably from hydrogen, nitrogen, oxygen, phosphorus and/or sulphur.

Most preferred organic groups comprise one or more of the following carbon containing moieties: alkyl, alkoxy, alkanoyl, carboxy, carbonyl, formyl and/or combinations thereof; optionally in combination with one or more of the following heteroatom containing moieties: oxy, thio, sulphinyl, sulphonyl, amino, imino, nitrilo and/or combinations thereof. Organic groups include all suitable chemically possible combinations in the same moiety of a plurality of the aforementioned carbon containing and/or heteroatom moieties (e.g. alkoxy and carbonyl if directly attached to each other represent an alkoxycarbonyl group).

The term ‘hydrocarbo group’ as used herein is a sub set of a organic group and denotes any univalent or multivalent moiety (optionally attached to one or more other moieties) which consists of one or more hydrogen atoms and one or more carbon atoms and may comprise one or more saturated, unsaturated and/or aromatic moieties. Hydrocarbo groups may comprise one or more of the following groups. Hydrocarbyl groups comprise univalent groups formed by removing a hydrogen atom from a hydrocarbon (for example alkyl). Hydrocarbylene groups comprise divalent groups formed by removing two hydrogen atoms from a hydrocarbon, the free valencies of which are not engaged in a double bond (for example alkylene). Hydrocarbylidene groups comprise divalent groups (which may be represented by “R2C═”) formed by removing two hydrogen atoms from the same carbon atom of a hydrocarbon, the free valencies of which are engaged in a double bond (for example alkylidene). Hydrocarbylidyne groups comprise trivalent groups (which may be represented by “RC≡”), formed by removing three hydrogen atoms from the same carbon atom of a hydrocarbon the free valencies of which are engaged in a triple bond (for example alkylidyne). Hydrocarbo groups may also comprise saturated carbon to carbon single bonds (e.g. in alkyl groups); unsaturated double and/or triple carbon to carbon bonds (e.g. in respectively alkenyl and alkynyl groups); aromatic groups (e.g. in aryl groups) and/or combinations thereof within the same moiety and where indicated may be substituted with other functional groups

The term ‘alkyl’ or its equivalent (e.g. ‘alk’) as used herein may be readily replaced, where appropriate and unless the context clearly indicates otherwise, by terms encompassing any other hydrocarbo group such as those described herein (e.g. comprising double bonds, triple bonds, aromatic moieties (such as respectively alkenyl, alkynyl and/or aryl) and/or combinations thereof (e.g. aralkyl) as well as any multivalent hydrocarbo species linking two or more moieties (such as bivalent hydrocarbylene radicals e.g. alkylene).

Any radical group or moiety mentioned herein (e.g. as a substituent) may be a multivalent or a monovalent radical unless otherwise stated or the context clearly indicates otherwise (e.g. a bivalent hydrocarbylene moiety linking two other moieties). However where indicated herein such monovalent or multivalent groups may still also comprise optional substituents. A group which comprises a chain of three or more atoms signifies a group in which the chain wholly or in part may be linear, branched and/or form a ring (including spiro and/or fused rings). The total number of certain atoms is specified for certain substituents for example C1 Norgano, signifies a organo moiety comprising from 1 to N carbon atoms. In any of the formulae herein if one or more substituents are not indicated as attached to any particular atom in a moiety (e.g. on a particular position along a chain and/or ring) the substituent may replace any H and/or may be located at any available position on the moiety which is chemically suitable and/or effective.

Preferably any of the organo groups listed herein comprise from 1 to 36 carbon atoms, more preferably from 1 to 18. It is particularly preferred that the number of carbon atoms in an organo group is from 1 to 12, especially from 1 to 10 inclusive, for example from 1 to 4 carbon atoms.

As used herein chemical terms (other than IUAPC names for specifically identified compounds) which comprise features which are given in parentheses—such as (alkyl)acrylate, (meth)acrylate and/or (co)polymer denote that that part in parentheses is optional as the context dictates, so for example the term (meth)acrylate denotes both methacrylate and acrylate.

Certain moieties, species, groups, repeat units, compounds, oligomers, polymers, materials, mixtures, compositions and/or formulations which comprise and/or are used in some or all of the invention as described herein may exist as one or more different forms such as any of those in the following non exhaustive list: stereoisomers (such as enantiomers (e.g. E and/or Z forms), diastereoisomers and/or geometric isomers); tautomers (e.g. keto and/or enol forms), conformers, salts, zwitterions, complexes (such as chelates, clathrates, crown compounds, cyptands/cryptades, inclusion compounds, intercalation compounds, interstitial compounds, ligand complexes, organometallic complexes, non stoichiometric complexes, π adducts, solvates and/or hydrates); isotopically substituted forms, polymeric configurations [such as homo or copolymers, random, graft and/or block polymers, linear and/or branched polymers (e.g. star and/or side branched), cross linked and/or networked polymers, polymers obtainable from di and/or tri valent repeat units, dendrimers, polymers of different tacticity (e.g. isotactic, syndiotactic or atactic polymers)]; polymorphs (such as interstitial forms, crystalline forms and/or amorphous forms), different phases, solid solutions; and/or combinations thereof and/or mixtures thereof where possible. The present invention comprises and/or uses all such forms which are effective as defined herein.

Polymers of the present invention may be prepared by one or more suitable polymer precursor(s) which may be organic and/or inorganic and comprise any suitable (co)monomer(s), (co)polymer(s) [including homopolymer(s)] and mixtures thereof which comprise moieties which are capable of forming a bond with the or each polymer precursor(s) to provide chain extension and/or cross-linking with another of the or each polymer precursor(s) via direct bond(s) as indicated herein.

Polymer precursors of the invention may comprise one or more monomer(s), oligomer(s), polymer(s); mixtures thereof and/or combinations thereof which have suitable polymerisable functionality.

A monomer is a substantially monodisperse compound of a low molecular weight (for example less than one kilodaltons) which is capable of being polymerised.

A polymer is a polydisperse mixture of macromolecules of large molecular weight (for example many thousands of daltons) prepared by a polymerisation method, where the macromolecules comprise the multiple repetition of smaller units (which may themselves be monomers, oligomers and/or polymers) and where (unless properties are critically dependent on fine details of the molecular structure) the addition or removal one or a few of the units has a negligible effect on the properties of the macromolecule.

A oligomer is a polydisperse mixture of molecules having an intermediate molecular weight between a monomer and polymer, the molecules comprising a small plurality of monomer units the removal of one or a few of which would significantly vary the properties of the molecule.

Depending on the context the broad term polymer may or may not encompass oligomers.

The polymer precursor of and/or used in the invention may be prepared by direct synthesis or (if the polymeric precursor is itself polymeric) by polymerisation. If a polymerisable polymer is itself used as a polymer precursor of and/or used in the invention it is preferred that such a polymer precursor has a low polydispersity, more preferably is substantially monodisperse, to minimise the side reactions, number of by-products and/or polydispersity in any polymeric material formed from this polymer precursor. The polymer precursor(s) may be substantially un-reactive at normal temperatures and pressures.

Except where the context indicates otherwise indicated herein polymers and/or polymeric polymer precursors of and/or used in the invention can be (co)polymerised by any suitable means of polymerisation well known to those skilled in the art. Examples of suitable methods comprise: thermal initiation; chemical initiation by adding suitable agents; catalysis; and/or initiation using an optional initiator followed by irradiation, for example with electromagnetic radiation (photo-chemical initiation) at a suitable wavelength such as UV; and/or with other types of radiation such as electron beams, alpha particles, neutrons and/or other particles.

The substituents on the repeating unit of a polymer and/or oligomer may be selected to improve the compatibility of the materials with the polymers and/or resins in which they may be formulated and/or incorporated for the uses described herein. Thus the size and length of the substituents may be selected to optimise the physical entanglement or interlocation with the resin or they may or may not comprise other reactive entities capable of chemically reacting and/or cross linking with such other resins as appropriate.

Further aspects of the invention are described in the claims.

The invention will now be illustrated by the following specific examples which are to be considered as illustrative only and not limiting the scope of the present invention.

### EXAMPLES

### Test Methods

The following test methods were to evaluate both the PSA properties and general properties. The test methods used for determining the PSA properties are those described in Test Methods for Pressure-Sensitive Tapes, 13th Edition, August 2001, Pressure-Sensitive Tape Council, Glenview, Ill., which is incorporated by reference herein.

### Peel Adhesion (PSTC-101)

Peel adhesion is the force required to remove a coated flexible sheet material from a test panel measured at a specific angle and rate of removal. In the examples this force is expressed in pound per inch (lb/in) width of coated sheet. The coating of the adhesive was applied to a silicone release paper. After the adhesive coating was cured using UV irradiation, it was bonded to a 2-mil thick Mylar film. The specimens of 1″ by 8″ were cut from the coated Mylar film. After conditioning 24 hours at 74° F. and 50% relative humidity, the release paper was removed and specimens were bonded to the horizontal surface of a clean stainless steel test plate. The bonds were then rolled using an auto roller. After conditioning the bonds for a specific dwell time, the bonds were peeled at 180° angle in a peel tester at a constant peeling rate of 12″/minute. The results are reported as an average load in lb/in.

### Shear Resistance (PSTC-107)

The shear resistance is a measure of the cohesiveness or internal strength of an adhesive. It is based upon the amount of force required to pull an adhesive strip from a standard flat surface in a direction parallel to the surface to which it has been affixed with a definite pressure. It is measured in terms of time required to pull a standard area of adhesive coated sheet material from a stainless steel test panel under a constant load.

The tests were conducted on adhesive coated strips applied to a stainless steel panel such that a 1″ by 1″ portion of each strip was in firm contact with the panel with one end portion of the tape being free. The panel with coated strip attached was held in a rack so that the panel forms an angle of 178°. After conditioning the bonds for 24 hours, a constant weight was hanged on the extended tape free end.

### Loop Tack Measurements (PSTC-16)

Loop tack was measured using the Loop Tack tester made by cutting 5″ by 1″ dimensions specimens of the Mylar coated laminates along the machine direction. After conditioning overnight at 74° F. and 50% relative humidity, the laminate was folded into a loop by taping the ends together. The loop was then mounted on the Loop tack tester and a stainless steel plate clamped to the base of the tester. When the test was started, the loop was brought in contact with the Stainless Steel plate and then withdrawn. The load it takes to withdraw from the plate was recorded as the loop tack in lb/in².

### Test Sample Preparation

All tapes for the PSA results herein were made by adhesive transfer coating. The uncured adhesive films were drawn down a silicone release paper (RP-12, from ChemInstruments) by using HLC-101 hot melt coater from ChemInstruments. The typical temperature setting was 130° C. for the top roll and 100° C. for the bottom roll.

The drawdown adhesives were then cured in air using two 600-watts per inch (W/inch) Fusion mercury vapor electrodeless UV lamps. The cured film was laminated with 2 mils thick polyester film using two double passes of an 8-inch hard rubber roller (5.03 Kg with handle held horizontally). The laminate was trimmed, cut into strips 1 inch 6 inches and conditioned in a constant temperature room before testing.

### Example 1

### Synthesis of Examples 1

204.75 g of Kraton L-2203, 56.16 g of aromatic modified aliphatic tackifier resin available commercially from ExxonMobil under the trade marks Escorez 2520, 251.67 g of hydrogenated cyclic aliphatic petroleum hydrocarbon tackifier resins available commercially from ExxonMobil under the trade marks Escorez 5380 were charged in a 2 L a round-bottomed flask. Put the flak in a 90° C.-100° C. oven to heat the mixture, allowed the tackifiers completely melt. Took the flask out from the oven, and started slow agitation to mix the polyol and melted tackifiers well while continued heating it to 100-110° C., and then held it at 100-110° C. With agitation, add in 0.22 g of BHT(butylated hydroxy toluene, an antioxidant available commercially from PMC Specialties under the trade designation CAO-3), then, begun continuously blowing dry air above the surface of the mixture, this drying process should last 2 hours to drive possible moisture out from either polyol or tackifiers. While the reactants were mixed and dried, the solution of 0.93 g of HEA/0.56 g of DBTDL, dibutyl tin dilaurate (available commercially from Air Products under the trade mark Dabco® T-12)/0.11 g of MeHQ, (Para-methoxyphenol available commercially from Aldrich Chemicals) and the solution of 15.63 g of MDI/28.66 g of HDODA should be made in a hood, respectively. HDODA (hexanediol diacrylate) is a difunctional reactive diluent, commercial product of Surface Specialties UCB. After the polyol and tackifiers were heated, mixed and dried for 2 hours, with moderate agitation, the solution of HEA/DBTDL/MeHQ was added in the reactor, and mixed well. The solution of MDI/HDODA was then slowly added in by using adding funnel. The addition time was 30-40 minutes. Under dry air blowing and moderate agitation held the reaction at 110° C. for at least 2 hours. The degree of reaction was checked by testing the level of NCO % until the level of NCO % was lower than 0.2%. Necessary additives were then post-added in, respectively. They were including: 0.28 g of BHT, 0.11 g of MeHQ, 5.58 g of Irgacure 184 and 2.79 g of Irganox 1010. Here, Irgacure 184 from Ciba Specialty Chemicals is a highly efficient non-yellowing photoinitiator which is used to initiate the photo-polymerization of chemically unsaturated pre-polymers. Irganox 1010 from Ciba Specialty Chemicals is phenolic primary antioxidant for process and long term thermal stabilization. Agitated the contents at 110° C. for at least 30 minutes to ensure that the inhibitor/antioxidant completely dissolve and homogeneously distribute in the product. Turn off the heater and agitation. Pour the product out into a containers and end of synthesis.

General Properties of Examples 1

The product was a very viscous liquid whose viscosity depended on temperature. The viscosity was determined by using Brookfield viscometer with spindle #28, and the results are shown in Table 1

TABLE 1
Temperature Dependent Viscosity of Example 1

| Temperature (° C.) | 80 | 90 | 100 | 110 | 120 |
|---|---|---|---|---|---|
| Viscosity (cPs) | 150,300 | 76,000 | 41,050 | 22,700 | 10,400 |

The viscosity data indicated that the product is coatable over a wide temperature range, 80 to 120° C.

### PSA Performance of Example 1

The 2-mil adhesive film sample was cured at the speed of 75 feet per minute (0.66 J/cm²). The adhesion performance results are given in Table 2.

TABLE 2
PSA Performance of Example 1 compared to
conventional solvent based PSA (Comp X)

| | Ex 1 | | Comp X | |
|---|---|---|---|---|
| 180° Peel on Stainless Steel, 20 minutes | 4.2 | lbs/in | 4.7 | lbs/in |
| Dwell | | | | |
| 180° Peel on Stainless Steel, 24 hours | 5.3 | lbs/in | 5.6 | lb/:ins |
| Dwell | | | | |
| 180° Peel on Polypropylene 20 minutes | 3.3 | lbs/in | <1.0 lbs/in | |
| Dwell | | | (zipping) | |
| 180° Peel on Polypropylene, 24 hours | 4.8 | lbs/in | <1.0 lbs/in | |
| Dwell | | | (zipping) | |
| Static Shear at 23° C. (1 × 1 inch, | >167 | hrs | 70 | hrs |
| 2 Kg) | | | | |
| Static Shear at 93° C. (1 × 1 inch, | >167 | hrs | 3 | hrs |
| 1 Kg) | | | | |

Before aging on polymeric PVC release liner

| | | | | |
|---|---|---|---|---|
| 180° Peel on Stainless Steel, 20 minutes | 4.2 | lbs/in | 4.9 | lbs/in |
| Dwell | | | | |

After aging a t 70° C. for 7 days on polymeric PVC release liner

| | | | | |
|---|---|---|---|---|
| 180° Peel on Stainless Steel, 20 minutes | 3.6 | lbs/in | 4.1 | lb/in |
| Dwell | | | | |

| | | |
|---|---|---|
| peel retention | 88% | 84% |

### Example 1 Shows the Following Properties:

Excellent adhesion to low surface energy substrate; Good adhesion to polar substrates; High cohesion; High temperature resistance, Good plasticiser resistance, Warm melt processing temperature 90° C. to 130° C.

### Example 2

### Synthesis of Example 2

204.75 g of Kraton L-2203, 83.82 g of aromatic modified aliphatic tackifier resin available commercially from ExxonMobil under the trade marks Escorez 2520, 223.29 g of hydrogenated cyclic aliphatic petroleum hydrocarbon tackifier resins available commercially from ExxonMobil under the trade marks Escorez 5380 and 0.22 g of BHT were charged in a 2 L a round-bottomed flask. Put the flak in a 93° C. oven to heat the mixture, allowed the tackifiers completely melt. Took the flask out from the oven, and started slow agitation to mix the polyol, melted tackifiers and BHT well while continued heating it to 100-110° C., and then held it at 100-110° C. With agitation, begun continuously blowing dry air above the surface of the mixture, this drying process should last 2 hours to drive possible moisture out from either polyol or tackifiers. While the reactants were mixed and dried, the solution of 0.93 g of HEA/0.56 g of DBTDL, 0.11 g of MeHQ, and the solution of 15.63 g of MDI/28.66 g of HDODA should be made in a hood, respectively. After the polyol and tackifiers were heated, mixed and dried for 2 hours, with moderate agitation, the solution of HEA/DBTDL/MeHQ was added in the reactor, and mixed well. The solution of MDI/HDODA was then slowly added in by using adding funnel. The addition time was 30-40 minutes. Under dry air blowing and moderate agitation held the reaction at 110° C. for at least 2 hours. The degree of reaction was checked by testing the level of NCO % until the level of NCO % was lower than 0.2%. Necessary additives were then post-added in, respectively. They were including: 0.28 g of BHT, 0.11 g of MeHQ, 5.57 g of Irgacure 184 and 2.79 g of Irganox 1010. Agitated the contents at 110° C. for at least 30 minutes to ensure that the inhibitor/antioxidant completely dissolve and homogeneously distribute in the product. Turn off the heater and agitation. Pour the product out into a containers and end of synthesis.

### General Properties of Examples 2

The product was a very viscous liquid whose viscosity depended on temperature. The viscosity was determined by using Brookfield viscometer with spindle #28, and the results are shown in Table 3

TABLE 3
Temperature Dependent Viscosity of Example 2

| Temperature (° C.) | 80 | 90 | 100 | 110 | 120 |
|---|---|---|---|---|---|
| Viscosity (cPs) | 171,500 | 82,130 | 44,450 | 23,250 | 13,950 |

The viscosity data indicated that the Example 2 is coatable over a wide temperature range, 80 to 120° C.

### PSA Performance of Examples 4

The 2-mil adhesive film sample was cured at the speed of 75 feet per minute (0.66 J/cm²). The adhesion performance results are given in Table 4.

TABLE 4
PSA Performance of Example 2

| | | |
|---|---|---|
| 180° Peel on Stainless Steel, 20 minutes Dwell | 4.1 | lbs/in |
| 180° Peel on Stainless Steel, 24 hours Dwell | 5.2 | lbs/in |
| Loop Tack on Stainless Steel | 2.4 | lbs/in² |
| Static Shear at 23° C. (1 × 1 inch, 2 Kg) | 8000 | min |

### ExampleS 3

### Synthesis of Example 3

204.75 g of Kraton L-2203, 56.16 g of aromatic modified aliphatic tackifier resin available commercially from ExxonMobil under the trade marks Escorez 2520, 251.67 g of hydrogenated cyclic aliphatic petroleum hydrocarbon tackifier resins available commercially from ExxonMobil under the trade marks Escorez 5380 and 0.22 g of BHT were charged in a 2 L a round-bottomed flask. Put the flak in a 93° C. oven to heat the mixture, allowed the tackifiers completely melt. Took the flask out from the oven, and started slow agitation to mix the polyol, melted tackifiers and BHT well while continued heating it to 100-110° C., and then held it at 100-110° C. With agitation, begun continuously blowing dry air above the surface of the mixture, this drying process should last 2 hours to drive possible moisture out from either polyol or tackifiers. While the reactants were mixed and dried, the solution of 0.93 g of HEA/0.56 g of DBTDL, 0.11 g of MeHQ, and the solution of 15.63 g of MDI/28.66 g of HDODA should be made in a hood, respectively. After the polyol and tackifiers were heated, mixed and dried for 2 hours, with moderate agitation, the solution of HEA/DBTDL/MeHQ was added in the reactor, and mixed well. The solution of MDI/HDODA was then slowly added in by using adding funnel. The addition time was 30-40 minutes. Under dry air blowing and moderate agitation held the reaction at 110° C. for at least 2 hours. The degree of reaction was checked by testing the level of NCO % until the level of NCO % was lower than 0.2%. Necessary additives were then post-added in, respectively. They were including: 0.28 g of BHT, 0.11 g of MeHQ, 5.57 g of Irgacure 184. Agitated the contents at 110° C. for at least 30 minutes to ensure that the inhibitor/antioxidant completely dissolve and homogeneously distribute in the product. Turn off the heater and agitation. Pour the product out into a containers and end of synthesis.

### General Properties of Example 3

The product was a very viscous liquid whose viscosity depended on temperature. The viscosity was determined by using Brookfield viscometer with spindle #28, and the results are shown in Table 5

TABLE 5
Temperature Dependent Viscosity of Produced Resin

| Temperature (° C.) | 80 | 90 | 100 | 110 | 120 |
|---|---|---|---|---|---|
| Viscosity (cPs) | 264,000 | 131,000 | 68,800 | 35,300 | 19,300 |

### Preparation of Example 4 and 5

Example 4 was made by hot-melt blend of 99.5 parts of Example 3 and 0.5% part of Irganox 1010.

Example 5 was made by hot-melt blend of 96 parts of Example 3 and 4 parts of Dipentaerythritol Hydroxy pentaacrylate (DPHPA, from UCB).

### PSA Performance of Examples 4 and 5

The 2-mil adhesive film samples were cured at the speed of 75 feet per minute (0.66 J/cm²). The pressure sensitive adhesion performance results are given in Table 6.

TABLE 6
PSA Performance of Example 4 and 5

| | Example 4 | | Example 5 | |
|---|---|---|---|---|
| 180° Peel on Stainless Steel, 20 minutes | 3.5 | lbs/in | 4.0 | lbs/in |
| Dwell | | | | |
| 180° Peel on Stainless Steel, 24 hours | 5.1 | lbs/in | 5.0 | lbs/in |
| Dwell | | | | |
| Static Shear at 23° C. (1 × 1 inch, | >20000 | min | >10000 | min |
| 2 Kg) | | | | |

1. A reaction product obtainable by polymerising the following materials, preferably in the absence of solvent:
(a) about 10% to about 80%, preferably from about 25% to about 50%, more preferably from 30% to about 40%, for example about 35% by weight of at least one polyol which has molecular weight at least 1000 daltons preferably from about 1,000 to 10,000 daltons, more preferably from about 2,000 to about 5,000 daltons, for example 3,000 daltons.
(b) from about 0.5% to about 20%, preferably from about 1.0% to about 10%, more preferably from about 1.0% to about 5%, for example about 3% by weight of at least one poly-isocyanate(s) for example from 2 to 4 different poly-isocyanate(s);
(c) from about 0.1% to about 10%, preferably from 0.1% to about 5% more preferably from 0.1% to about 1.0% most preferably from about 0.1% to about 0.5% for example about 0.2% by weight of at least one hydroxyl (meth)acrylate(s) for example from 2 to 6 different hydroxyl (meth)acrylate(s).
(d) from about 10% to about 80%, preferably about 30% to about 60%, more preferably about 40% to about 60%, most preferably about 50% to about 60%, for example about 55% by weight of one or several of tackifier resins that are compatible to these materials (such as these oligomers/polymers), for example hydrocarbon tackifiers;
(e) optionally from about 0% to about 90%, preferably about 1% to about 30% more preferably about 2% to about 25%, most preferably about 3% to about 10%, for example about 5% by weight of one or several of multifunctional (meth)acrylate monomers that are compatible these materials (such as these oligomers/polymers)
(f) optionally from about 0.1% from about 10.0%, preferably from about 0.5% to about 5% by weight of photo-initiator(s), preferably from about 0.5% to about 1.5%, for example about 1.0% by weight of photo-initiator(s).Optionally, no photoinitiator is used if the formulation is to be cured by electron beam; and
(g) optionally from about 0% to about 10% by weight of other additives such as antioxidant (s), UV-stabilizer(s), wetting agent(s), flowing agent(s) and any other additive that would be well known to those skilled the art.

2. A polymer as claimed in claim 1 where the (meth)acrylates comprises an average from about 1.5 to about 2.5, more preferably about 2.0 hydroxy groups per molecule.

3. A process comprising the step of polymerising the materials in claim 1, in a single vessel in the absence of solvent.

4. A radiation curable adhesive, preferably a pressure sensitive adhesive, obtainable from the process of claim 3.

5. An adhesive as claimed in claimed 4 which adheres to a low surface energy substrate (such as polypropylene) with a force of at least about 1.5 lb/in, preferably 2.0 lb/in in the test methods described herein.

6. A substrate coated with an adhesive as claimed in claim 4.

7. The radiation curable adhesive according to claim 4 comprising the polymer of claim 1.

8. The radiation curable adhesive according to claim 4 comprising the polymer of claim 2.
